(19) United States
(12) Patent Application Publication
(10) Pub. No.: US 2018/0134414 A1
(43) Pub. Date: May 17, 2018

(54) HIGH ALTITUDE SPACE LAUNCHER

(71) Applicant: ABBAS ALIKOUHI, URMIA (IR)

(72) Inventor: ABBAS ALIKOUHI, URMIA (IR)

(21) Appl. No.: 15/869,334

(22) Filed: Jan. 12, 2018

Related U.S. Application Data
(60) Provisional application No. 62/446,345, filed on Jan. 13, 2017.

(51) Int. Cl. B64G 1/00; B64B 1/06; B64B 1/58; B64B 1/70; F41B 11/68; F41B 11/70

(52) U.S. Cl. CPC B64G 1/005; B64B 1/06; B64B 1/58; B64B 2201/00; F41B 11/68; F41B 11/70; B64B 1/70

(57) ABSTRACT

Disclosed is a high altitude space launcher system for transferring payloads from surface to orbit at a significantly lower cost than conventional rockets. It comprises a aerostat lifted one stage light gas gun operating in stratosphere that shoots rocket assisted projectiles containing payload at near orbital velocities to a low angle trajectory. Alternatively, to launch acceleration sensitive payloads such as astronauts the light gas gun is replaced with a muzzle loaded conventional gun that shoots a single stage rocket at a much lower velocity. The system is mostly static structure, attached to a tether-elevator that moors it to land or a ship and provided it with electricity and lifts the projectiles to the gun.

### PRIORITY CLAIM

This invention claims priority to an earlier provisional application (62/446,345), filed on 13 Jan. 2017; which is incorporated entirely as originally filed in this specification.

### FIELD OF THE INVENTION

Disclosed is a high altitude launch system for transferring payloads from surface to orbit at a significantly lower cost than conventional rockets.

The Present invention relates to space transportation and more particularly to a method for providing orbital space transportation of payloads from ground surface to orbit.

### BACKGROUND OF THE INVENTION

As of early 2017, the only devices mankind has used for delivering payloads to orbit are multistage rockets, ground based guns and space elevators. But these ideas turned to be ineffective or infeasible.

Aerodyne lifted rockets provide marginal savings, aerostat lifted rockets have been patented but not used, ground based guns have to shoot their hypervelocity payload in a dense atmosphere which loses a lot of velocity and mass to drag and heating with possibility of destabilizing, tumbling and disintegrating, and space elevators are extremely heavy structures that have to be put in orbit first and no known bulk made material has sufficient specific strength for this purpose even with substantial amount of tapering.

### SUMMARY

Guns are superior options to rockets for launching acceleration resistant payloads because they are not spent during use.

There are two major types of guns capable of reaching the hypervelocity speeds required for orbital launch: Electromagnetic guns and light gas guns. Light gas guns were chosen over electromagnetic guns for launching the payload for the following reasons:
Electromagnetic guns have lower limits on scalability, because energy in a magnetic system scales as the fifth power of dimension rather than the common third power. This makes their muzzle velocity proportional to their caliber. In other words, small EM guns do not show faster than conventional guns, and large EM guns blow themselves apart due to large magnetic pressure. On the other hand, light gas guns are highly scalable.
Railguns have the problem of several rail erosion; and coilguns require precise, high power switches.
Capacitors and inductors used for powering EM guns have a much lower specific energy than thermal and chemical energy storages used in light gas guns. This makes EM guns heavier.
EM guns are still experimental, but light gas guns have been in use for about 60 years.

There are two major types of light gas guns: One stage and two stage. One stage light gas guns were chosen over two stage guns for the following reasons:
two stage guns use a very heavy piston.
two stage guns require a cylindrical pressure vessel to accommodate the piston. On the other hand one stage guns can use a spherical pressure vessel which has twice the efficiency in containing pressure.
Automating the reloading process of one stage guns is much easier due to having fewer moving parts and having no disposable parts such as a rupture disk.

However, using a single shot two stage light gas gun can't be ruled out for experimental or demonstrational prototypes.

Lifting a gun to a high altitude has the benefit of bypassing a substantial thickness of the atmosphere, therefore less velocity is lost to drag and lower shooting angles are possible. Only 50% of the atmosphere is above 5.6 km, 10% above 16 km and 1% above 30 km. The highest land near the equator is the 6.263 km high Chimborazo volcano in Ecuador, compared to the airplane altitude record of 37.65 km, manned balloon record of 41.424 km and unmanned balloon record of 53 km.

There are two major types of aerial vehicles: Aerodynes (heavier than air) and aerostats (lighter than air). Aerostats have been chosen over aerodynes for the following reasons:
Aerodynes have upper limits on scalability, because weight is a force that scales with dimension cubed, but engine power, thrust, drag and lift scale as dimension squared. This makes large aerodynes infeasble even if larger wings and higher speeds are used to augment the lift. But since aerostats have a lift force equal to their weight, they can be arbitrarily large or small.
Aerostats don't use energy to stay afloat.
Aerostats have higher operational altitude.
Aerostats have been used for about 230 years against 110 years for aerodynes.

The High Altitude Space Launcher is an automatic light gas gun (preferably one stage) that shoots rocket assisted projectiles at high-hypersonic velocities (for acceleration resistant payloads) or an automatic conventional gun (preferably muzzle loaded) that shoots single stage rockets at transitional altitude that can be as low as the tropopause or as high as the stratopause by an aerostat system (preferably balloons) and is moored the ground or a ship by a tether-elevator that supplies it with electric power and lifts the projectiles or rockets from the surface to the gun.

There are also a number of other components on this system that are responsible for handling the payloads, position, altitude and buoyancy control, recoil neutralization and gun reloading.

The rocket booster of the light gas gun launched projectile and the single stage rocket of the conventional gun launched rocket are detachable and reusable. The rocket booster of the projectile is activated around the apoapsis of the trajectory but the single rocket is activated upon leaving the launcher.

### BRIEF DESCRIPTION OF THE DRAWINGS

FIG. 1: is a side view of the complete system with one stage light gas gun for rocket assisted projectiles. Despite not being used at the same time, both recoil compensation thermal rockets (9) and recoil compensation umbrella-drogue chute (6) are shown for simplicity.

FIG. 2: Is a side view of the muzzle loaded conventional gun for single stage rockets. Aerostats (11) and the crawler (1) are not shown.

FIG. 3: Is a radial cross section of the gas baffle showing the barrel (14) and the internal frame (15).

FIG. 4: Is a rocket assisted projectiles from rear and axial cross section.

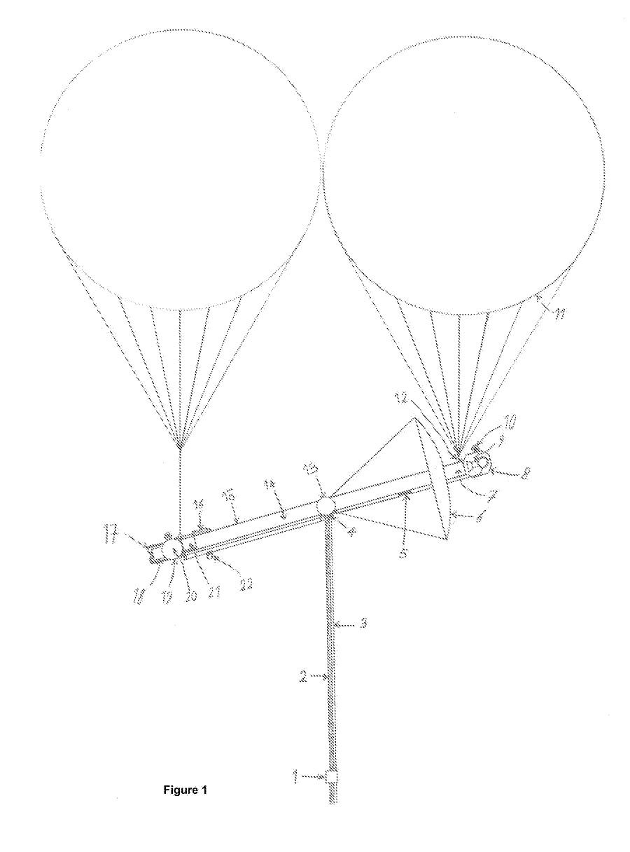

### DETAILED DESCRIPTION OF THE PREFERRED EMBODIMENT(S) AND INVENTION

The main external components are aerostats (11), the tether-elevator (2), the crawler (10), the conveyor crane (22), recoil compensation thermal rockets (9) or an umbrella-drogue chute (6), altitude control propellers (10), buoyancy control vessels (13) and angle control winches (12).

Aerostat (11) may be in a number of shapes, sizes and arrangements such as one of multiple balloons or blimps holding the gun by a cable that is attached to their throat or surrounding net. These aerostat may be made from a number of polymer sheets or films such as polyisoprene, polychloroprene, polyethylene terephthalate or polyethylene naphthalate and may or may not be coated with resistant metals such as aluminum, copper, silver or gold. It should be noted that since the system is mostly static structure, it's not necessary to use rigid body airships. If hydrogen is used as the lifting gas, the aerostats may have a double shell design with the intermediate space filled with an inert gas such as helium, neon, argon or nitrogen.

The tether-elevator (2) is a ribbon like structure attached to the gun in the middle and is made of non-conductive high specific strength material such as polymer or glass fibers and moored to a support land facility or structure ship on or near the equator. The tether-elevator is capable of vertically displacing the system, aided by the by buoyancy control vessels (13). The tether-elevator also contains winch (4) reelable electric cabals (3) made of conductive high specific strength material such as aluminum or magnesium alloy in non-conductive tubes for supplying power to the gun thermal storage (18), recoil compensator rocket-thermal storage (9), attitude control propellers (10), buoyancy control pressure vessels (13), angle control winches (12), gun breech (21), conveyor crane (22), gas pumps (5) and (16) valves. The cables are reeled up in the case of thunderstorms to prevent grounding of the system. If tornadoes or hurricanes are common in the troposphere beneath the system, the whole tether-elevator should be reelable. Both the tether-elevator and the electric cables may be tapered as required.

The crawler (1) climbs or descends the tether-elevator (2) by electric powered wheels and lifts the projectiles to be launched to the gun. It also can lift light gas canisters for the gun or the aerostat as per requirement. The crawler is battery or solar powered and does not use power from the electric cables (3) on tether-elevator.

The conveyor crane (22) is a belt or chain mounter crane designed to transport the projectiles from the crawler (1) to the gun breech (21).

Shooting the projectile imparts recoil momentum on the system. The muzzle brake (7) on the gun does not contribute to recoil neutralization since it opens the gas baffle (15) which is a part of the gun itself. If drag on the aerostats (11), traction from the tether-elevator (2) or gun-to-projectile mass ratio are not high enough to attenuate the recoil, recoil compensators are used: Recoil compensation thermal rockets (9) for higher altitudes or recoil compensation umbrella-drogue chute (6) for lower altitudes.

Recoil compensation thermal rockets (9) are compressed air thermal rockets that feed compressed air thermal rockets that feed compressed air from a pressure vessel into a thermal storage then to a rocket nozzle which fires in the opposite direction to the gun. These are placed at two sides of the buffer space (8) of the gun to act like muzzle brakes. The main difference between the thermal storage used in the recoil compensation thermal rockets and the one used in the light gas gun itself (18) is that the former uses much lower temperatures and hot oxygen resistant materials. An example of a good phase change material combination for this purpose is silica contained molten silicon.

Recoil compensation umbrella-drogue chute (6) is a concave, circular piece of fabric or sheet that is kept open by radial ribs and is kept from exceeding the opening by cables attached from its edges to the gas baffle (15). It simply slows down the system to a halt after firing by pushing on the surrounding air.

Altitude control propellers (10) are large electric powered propellers that control the horizontal position and horizontal direction of the system.

Buoyancy control vessels (13) are submarine ballast tank inspired compressed air vessels with pumps and valves that in addition on the tether-elevator (2), control the vertical position of the system by filling up or emptying. The pressure thus density of the air inside these vessels dictate buoyancy of the system. To evenly distribute their force, these vessels are placed at the middle of the gun, where the tether-elevator attaches to the gun. These vessels are not meant to be capable of dramatic altitude control such as landing or taking off the system, but serve mainly to reduce stress on the tether-elevator during mass fluctuations which mainly come from the crawler (1) and projectiles. Since buoyancy control vessels are similar to recoil compensation rockets they can share some parts such as the air pump (5).

Angle control winches (12) attach the gun to the aerostats (11). They control the vertical direction of the gun.

The light gas gun components are the light gas reservoir vessel (19), the thermal storage (18), vessel heating capillaries (20), the gun chamber and breech (21), the barrel (14), the muzzle brake (7), the gas baffle (15) with internal frame (26) and the buffer space (8).

The thermal storage (18) is a high surface to volume ratio, electrically heated, high thermal capacity device designed to heat the working gas. It can be in the shape of parallel plates, a honeycomb or a pebbled. Two types of mechanisms could be used to store heat: Temperature change material (TCM) and phase change material (PCM). Phase change was chosen over temperature change for the following reasons:
Temperature remains constant during freezing of PCMs. This allows a very efficient control over pressure in the gun which leads to consistent performance.
Temperature remains constant during freezing of PCMs. This enables use of refractory ceramics for containing molten PCM in addition to refractory alloys. Normally, this is not possible for TCMs because ceramics are vulnerable to thermal shock from changing temperatures unless the scale is too small to create temperature gradients.
Enthalpy of fusion provides a much higher specific energy, comparable to what heat capacity offers over a temperature change of kilokelvins.

However, using temperature change material can't be ruled out for experimental or demonstrational prototypes.

An example of a good TCM combination is molybdenum contained near boiling point liquid lithium. An example of a good PCM combination is boron nitride contained near melting point liquid boron. Graphite clad molten boron carbide might be even superior, but there is not enough data available to judge this combination.

The barrel (14) which is located inside (15) is made from lightweight materials. The recommended structure is a carbon fiber wound stainless steel barrel with a refractory alloy lining. The barrel operates at a pressure of tens of hundreds of megapascals, a temperature of kilokelvins and accelerates the projectile to e velocity of kilometer per second. Because thermal conduction loses effectiveness the larger the scale becomes, wider, longer barrels may need a cooling system to accomplish an acceptable firing rate, such as a liquid cooling jacket around the carbon fiber winding.

The light gas reservoir (19) has a similar recommended structure, but it may or may not have a refractory alloy liner. Although it's possible to make the reservoir vessel in the shape of a hemisphere capped cylinder, a spherical shape is preferable because this shape is twice lighter for the same volume and pressure. The gas reservoir opens into the thermal storage (18) by one or multiple valves and pipes (17) and is filled with recycled light gas compressor (16) from the gas baffle (15), or initially from a crawler (1) lifted gas canister. The light gas used may be hydrogen or helium or a mixture of both. Hydrogen offers higher muzzle velocity since it has a lower molecular mass and low cost, and helium offers long life since it's completely inert chemically.

The gun chamber and breech (21) are loaded by the conveyor crane (22) with the projectile. It pops downwards by a powered mechanism which may be electrical, pneumatic or hydraulic, similar to how a revolver pistol chamber pops sideways for reloading.

The muzzle brake (7) which is located inside (15) redirects the light gas into the gas baffle (15) at the end of the barrel (14). Unlike common muzzle brakes, it doesn't contribute to recoil reduction.

The gas baffle (15) is a thinner, wider pressure vessel around most of the barrel (14) designed to collect the light gas from the muzzle brake (7), hold it and cool it until a gas compressor (16) recycles it into the reservoir vessel (19). As the pressure drops, the gas compressor switches to input from an intermediate vacuum pump. Heat radiators and heat pipes for cooling the light gas faster or thermal insulation and heat engines to recycle some energy are optional. Gas baffle also keeps the barrel from bending by an internal truss frame (26).

Vessel heating capillaries (20) which are located inside (19) pass the heated light gas from the thermal storage (18) through the light gas reservoir vessel (19) and end in the gun breech (21). This raises temperature in the vessel to mitigate pressure drop as the vessel is emptied.

The buffer space (8) is a vacuum vessel between the gun muzzle and the outside atmosphere. It has two quick valves designed to isolate the light gas from the outside. As soon as the projectile leaves the muzzle, the muzzle valve closes and the external valve opens. The projectile continues through the external valve into the atmosphere, and subsequently space.

The launching sequence proceeds like the following: The cables (3) provide the power to heat the thermal storages (18) and (9), the projectile is lifted from the base facility or ship to the gun by the crawler (1) and transported to the gun chamber 921) by the conveyor crane (22). When the projectile is loaded, high pressure light gas from the reservoir vessel (19) is fed into the thermal storage (18) by pipes (17), passed through the capillaries (20) in the reservoir vessel and then reaches the gun breech (21) to push the projectile. At the end of the barrel, light gas leaks backwards through the muzzle brake (7) into the gas baffle (15). The projectile continues through a slightly wider barrel into the buffer space (8) and exits the system. Then gas pump (16) recycles the light gas from the baffle into the reservoir vessel. The recoil compensation thermal rockets (9) fire before, during and after launch. Alternatively in a lower altitude system, the record compensation umbrella-drogue chute (6) slows down the gun.

The projectiles in FIG. 4 are heat shielded (30) because they are shot at high hypersonic speeds into a tenuous atmosphere. They are also rocket assisted, with a delta v capability in the ranges of hundreds of meters per second because they are shot into an earth crossing trajectory rather than an orbit, and some delta v is required around the apoapsis to turn the ballistic trajectory inti a circular orbit. This delta v comes from the rocket booster which fired near the apoapsis. The rocket booster is a short cylinder shaped section at the bottom of the projectile. The rocket booster is a short cylinder shaped section at the bottom of the projectile. It consists of multiple small micro-combustion engines (27) that use a high specific impulse bipropellant from multiple small propellant tanks (29) plus one or more parachute containers (28). When the apoapsis burn is complete, the booster and the heat-shield (30) detach from the orbiting payload (31), combine, make a reverse burn, reenter and land by parachute (28) to be reused. The final orbital height, velocity lost to drag and the payload ratio depend on the angle of launch. Higher angle launched result in higher orbits ad less drag loss.

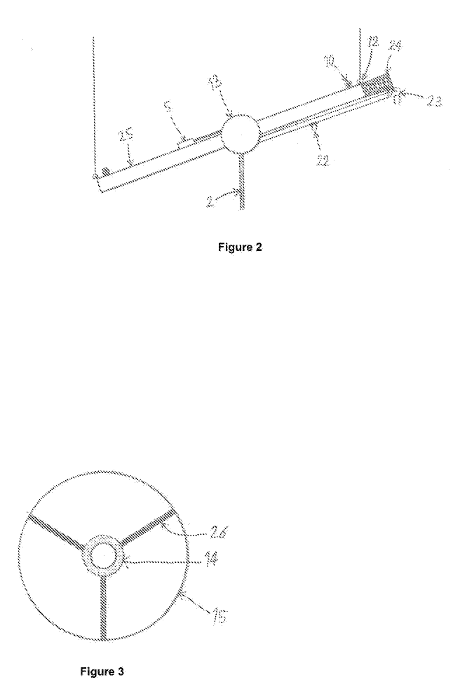

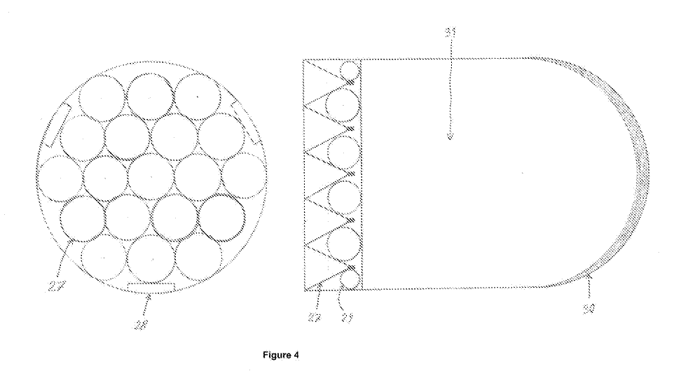

Acceleration sensitive payloads like astronauts could still benefit from this launch platform. For this purpose the light gas gun is replaced with a conventional gun of FIG. 2 that uses a lower acceleration to shoot a larger single stage to a lower velocity of hundreds of meters per second.

The single stage rocket, unlike the light gas gun projectile, is a proper conventional rocket with a delta v capability in the kilometer per second range that fires as soon as it leaves the muzzle. Augmenting conventional rockets with this system has the benefits of having less altitude to climb, requiring less delta v for orbit and eliminating the need for high impulse density, low specific, impulse propellants such as APCP. Therefore, all the propellant could be LOX/LH2 or LOX/Liquid methane, making a single stage to orbit rocket possible. These single stage rockets could be modeled after the last stages of multistage rockets, such as S-IVB stage of Saturn V. After placing the payload in orbit, the rocket either makes a reverse burn to reenter and land by parachute for reuse or is scrapped for its parts and material.

The conventional gun that replaces light gas gun for launching rockets is a muzzle loaded gun (25) similar to mortars or caseless grenade launchers. Since it operates at a much lower pressure and temperature there is no need for refractory alloy lining or carbon fiber winding. While the rocket is loaded through the nuzzle by a muzzle loader (23) that rotates up to transfer the rocket from the conveyor crane (22) to the muzzle brake (24), the solid propellant used to launch it could be loaded in a number of ways, such as through the gun breech or held at the bottom of the rocket. Unlike the light gas gun, this conventional gun has a real muzzle brake (24) to attenuate recoil. This eliminates the need for recoil compensation rockets or chutes. Also since a rocket us much heavier than a projectile for the same system mass, larger buoyancy control vessels (13) and a thicker tether-elevator (2) are required. Since there are no thermal storages in this version, and could come from onboard photovoltaic cell charged batteries.

1- A high altitude space launcher comprising:
Aerostats; a tether-elevator; a crawler; a conveyor crane; a recoil compensation; an altitude control propeller; a buoyancy control vessel and an angle control winches.

2- The space launcher of claim 1, wherein said aerostat comprises different shapes, sizes and arrangements; comprising but not limited to multiple balloons or blimps holding a gun by a cable that is attached to their through or surrounding net.

3- The space launcher of claim 2, wherein said aerostats is made from a number of polymer sheets or films comprising polyisoprene, polychloroprene, polyethylene terephthalate or polyethylene naphthalate and may or may not be coated with resistant metals; wherein said resistant metals comprising aluminum, copper, silver or gold.

4- The space launcher of claim 3, wherein if hydrogen is used as a lifting gas, said aerostats comprises a double shell design having an intermediate space filled with an inert gas; comprising helium, neon, argon or nitrogen; and the rest filled with hydrogen.

5- The space launcher of claim 4, further comprising a one stage light gas gun.

6- The space launcher of claim 5, wherein said tether-elevator is a ribbon like structure attached to a middle section of said gun; and wherein said tether-elevator is made of non-conductive high specific strength material comprising but not limited to various polymers or glass fibers and is moored to a support land facility or structure ship on or near the equator.

7- The space launcher of claim 6, wherein said tether-elevator vertically displaces said system aided by said buoyancy control vessel.

8- The space launcher of claim 7, wherein said tether-elevator further comprises a winch, reelable electric cables made of conductive high specific strength material; wherein said conductive material comprising aluminum or magnesium alloy in non-conductive tubes therefore supplying power to multiple units comprising gun thermal storage, recoil compensator rocket-thermal storage, altitude control propellers, buoyancy control pressure vessels, said angle control winches, gun breech, conveyor crane, gas pumps and valves of different sections of said system.

9- The space launcher of claim 8, wherein said cables are reeled up in case of thunderstorms, preventing said system form grounding; and wherein tornadoes or hurricanes are common beneath sad system, said entire tether-elevator is reelable.

10- The space launcher of claim 9, wherein said crawler climbs or descends said tether-elevator by electric powered wheels and lifts projectiles to be launched to said gun.

11- The space launcher of claim 10, wherein said crawler lifts canisters for said light gas gun or said aerostat.

12- The space launcher of claim 11, wherein said crawler uses battery or solar power for function and does not use power from said electric cables of said tether-elevator.

13- The space launcher of claim 12, wherein said conveyor crane is a belt or chain mounter crane, transporting said projectiles from said crawler to said gun breech.

14- The space launcher of claim 13, wherein recoil compensators are activated and used when a drag of said aerostats, traction from said tether-elevator or said gun to projectile mass ratio are not high enough to attenuate a recoil in a momentum of said system, and wherein said recoil compensators comprises a recoil compensation thermal rockets for higher altitudes and a recoil compensation umbrella-drogue chute for lower altitudes.

15- The space launcher of claim 14, wherein said recoil compensation thermal rockets are compressed air thermal rockets; wherein compressed air will be fed into a rocket thermal storage from a pressure vessel; and then into a rocket nozzle; therefore due to this action said gun is fired in an opposite direction.

16- The space launcher of claim 15, wherein said rocket thermal storage uses much lower temperature and hot oxygen resistant material.

17- The space launcher of claim 14, wherein said recoil compensation umbrella-drogue chute is a concave piece of fabric, kept open at a fixed radius by radial ribs and cables attached from its edge to a gas baffle.

18- The space launcher of claim 16, wherein said altitude controlled propellers comprise large electric powered propellers, controlling horizontal position and direction of said system.

19- The space launcher of claim 18, wherein said buoyancy control vessels are submarine ballast tank inspired compressed air vessels, comprising said pumps and valves in addition to said tether-elevator; wherein a pressure density of air inside said vessels dictate buoyancy of said system.

20- The space launcher of claim 19, wherein said gun further comprises said vessels attached to a middle section of said gun; where said tether-elevator is attached to said gun.

21- The space launcher of claim 20, wherein said angle control winches attach said gun to said aerostats and control a vertical direction of said gun.

22- The space launcher of claim 21, wherein said light gas gun further comprises a light gas reservoir vessel, said thermal storage, vessel heating capillaries, a gun chamber, a breech, a barrel, a muzzle brake, said gas baffle with internal frame and buffer space.

23- The space launcher of claim 22, wherein said thermal storage comprises a high surface to volume ratio, electrically heated, high thermal capacity device capable of heating said gas inside said gun; and wherein said thermal storage comprises a parallel plates, honeycomb or a pebbles shape; and stores heat via phase change material mechanism (PCM).

24- The space launcher of claim 23, wherein said barrel inside said gun comprises lightweight materials, comprising structures made of carbon fiber wound stainless steel with a refractory alloy lining.

25- The space launcher of claim 24, wherein said gas reservoir has a similar structure as said barrel with or without said alloy lining; and comprises a shape similar to that of a hemisphere capped cylinder and preferably a spherical shape; wherein said gas reservoir opens into said thermal storage by one of multiple said valves and pipes and is filled with recycled light gas compressor from said gas baffle or initially from said crawler lifted gas canister.

26- The space launcher of claim 25, wherein said gas comprises hydrogen, helium or a mixture of both; wherein hydrogen offers a higher muzzle velocity since it has a lower molecular mass than helium which offers long life since it's completely inert chemically.

27- The space launcher of claim 26, wherein said gas chamber and said breech are loaded by said conveyor crane with said projectiles; wherein said gun chamber and breech pops downwards using an electrical, pneumatic or hydraulic powered mechanism.

28- The space launcher of claim 27, wherein said muzzle brake redirects said light gas into said gas baffle at an end of said barrel; and wherein said gas baffle collects said light gas from said muzzle brake and holds and cools said light for said gas compressor to in order to recycle it into said reservoir vessel; wherein an internal truss frame of said gas baffle prevents said barrel from bending.

29- The space launcher of claim 28, wherein said buffer space is a vacuum vessel between said gun muzzle and an outside atmosphere, and further comprises two quick valves isolating said light gas from outside; wherein when said projectiles leave said muzzle, said quick valves closes and external valves open.

30- The space launcher of claim 29, wherein said system further comprises rocket boosters that are short cylinder shaped sections at a bottom of said projectiles; comprising multiple small micro-combustion engines, using a high specific impulse bipropellant from multiple small propellant tanks and one or more parachute containers; wherein said rocket booster of said light gas gun and a heat-shield around said projectiles are detachable and reusable.
